(19) United States
(12) Patent Application Publication
(10) Pub. No.: US 2024/0336162 A1
(43) Pub. Date: Oct. 10, 2024

(54) Power Supply System for Vehicles

(71) Applicant: TOYOTA JIDOSHA KABUSHIKI KAISHA, Toyota-shi (JP)

(72) Inventor: Tomohiro NAREMATSU, Nisshin-shi (JP)

(21) Appl. No.: 18/625,446

(22) Filed: Apr. 3, 2024

(30) Foreign Application Priority Data
Apr. 7, 2023 (JP) 2023-062863

(51) Int. Cl. B60L 58/20

(52) U.S. Cl. CPC B60L 58/20; B60L 2210/10

(57) ABSTRACT

When the auxiliary battery is being charged and the difference between the voltage value of the auxiliary battery and the target voltage value of the DCDC converter is equal to or greater than the determination voltage value, the vehicle power supply system determines that the DCDC converter is abnormal, stops the DCDC converter, drives the alternator, and decreases the determination voltage value when the voltage value of the auxiliary battery is equal to or less than the predetermined voltage value or the internal resistance value of the auxiliary battery is equal to or less than the predetermined resistance value.

### CROSS REFERENCE TO RELATED APPLICATION

This application claims priority to Japanese Patent Application No. 2023-062863 filed on Apr. 7, 2023, which is incorporated herein by reference in its entirety including the specification, claims, drawings, and abstract.

### TECHNICAL FIELD

The present disclosure relates to a vehicle power supply system.

### BACKGROUND

Some vehicle power supply systems include an alternator that generates electric power by rotation of an engine and supplies electric power to auxiliary unit, and a DCDC converter that is connected in parallel with the alternator and converts a voltage to supply electric power of a driving battery to the auxiliary unit. The auxiliary unit includes an auxiliary load and an auxiliary battery.

In the vehicle power supply system, the DCDC converter is normally driven to supply the electric power of the drive battery to the auxiliary unit, and the engine and the alternator are driven to supplement the electric power to the auxiliary unit when the electric power consumption of the auxiliary load is equal to or higher than the predetermined electric power.

For example, Japanese Patent Laying-Open No. 2018-118578 discloses a technique of stopping a DCDC converter, driving an alternator, and supplying electric power to auxiliary unit when an abnormality occurs in the DCDC converter in the vehicle power supply system.

### SUMMARY

However, for example, the auxiliary battery may be degraded or the remaining capacity of the auxiliary battery may be small. At this time, when the DCDC converter is stopped and the alternator is driven as described above, a short-term large current is generated in an auxiliary load having a large load, such as a brake motor or a power steering motor. At this time, there is a possibility that the voltage of the auxiliary battery significantly decreases and becomes lower than the operating voltage of the auxiliary load, that is, a so-called battery runaway may occur.

Accordingly, an object of the present disclosure is to provide a power supply system for a vehicle capable of preventing a voltage of an auxiliary battery from significantly decreasing and falling below an operation voltage of an auxiliary load.

A vehicle power supply system according to the present disclosure, comprises an auxiliary unit, an auxiliary battery that supplies electric power to the auxiliary unit, an alternator that generates electric power by rotation of an engine and supplies electric power to the auxiliary unit and the auxiliary battery; and a DCDC converter that is connected in parallel with the alternator and converts a voltage to supply electric power of a driving battery to the auxiliary unit and the auxiliary battery. When the auxiliary battery is being charged and a difference between a voltage value of the auxiliary battery and a target voltage value of the DCDC converter is equal to or greater than a determination voltage difference, it is determined that the DCDC converter is abnormal, the DCDC converter is stopped, and the alternator is driven and, wherein when the voltage value of the auxiliary battery is equal to or less than a predetermined voltage value or an internal resistance value of the auxiliary battery is equal to or less than a predetermined resistance value, the determination voltage difference is lowered.

A vehicle power supply system according to the present disclosure, wherein when the auxiliary battery is not being charged and the current value of the auxiliary battery on a discharge side is equal to or greater than a determination current value, it is determined that the DCDC converter is abnormal, the DCDC converter is stopped, and the alternator is driven, and when the voltage value of the auxiliary battery is equal to or less than the predetermined voltage value or the internal resistance value of the auxiliary battery is equal to or less than the predetermined resistance value, the determination current value is lowered.

According to the vehicle power supply system of the present disclosure, it is possible to prevent the voltage of the auxiliary battery from significantly decreasing and falling below the operating voltage of the auxiliary unit.

### BRIEF DESCRIPTION OF DRAWINGS

FIG. 1 is a block diagram showing a vehicle power supply system as an example of an embodiment.

FIG. 2 is a block diagram showing a configuration of a power supply ECU.

FIG. 3 is a flowchart showing a flow of DCDC abnormality determination control.

### DESCRIPTION OF EMBODIMENTS

Hereinafter, an example of an embodiment of the present disclosure will be described in detail. In the following description, specific shapes, materials, directions, numerical values, and the like are examples for facilitating understanding of the present disclosure, and can be appropriately changed in accordance with applications, purposes, specifications, and the like.

### [Vehicle Power Supply System]

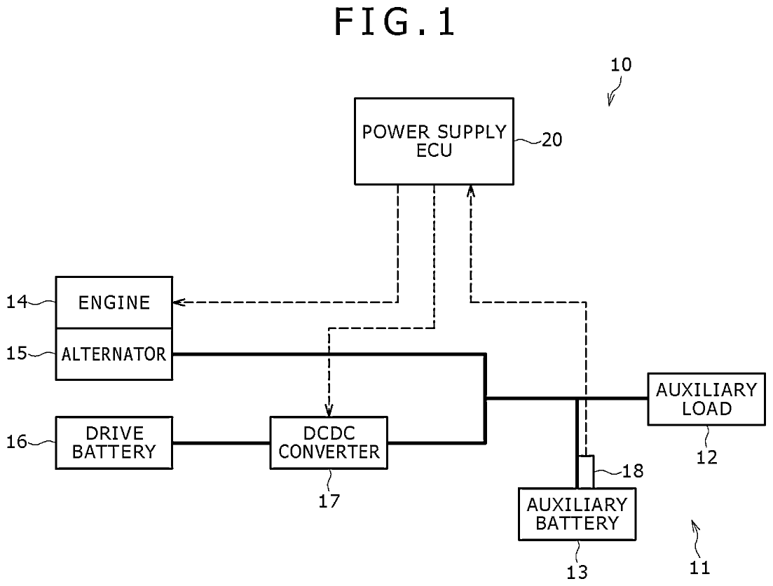

A vehicle power supply system 10 will be described with reference to FIG. 1.

The vehicle power supply system 10 is mounted on a vehicle. The vehicle is a hybrid electric vehicle (HEV) that runs by driving a gasoline engine and a motor.

The vehicle power supply system 10 includes an alternator 15 that generates electric power by rotation of the engine 14 and supplies electric power to the auxiliary unit 11, a DCDC converter 17 that is connected in parallel with the alternator 15 and converts a voltage to supply electric power of the driving battery 16 to the auxiliary unit 11, and a power supply ECU (Electronic Control Unit) 20 that executes abnormality determination control, which will be described in detail later. The auxiliary unit 11 includes an auxiliary load 12 and an auxiliary battery 13.

The vehicle power supply system 10 normally drives the DCDC converter 17 to supply the power of the drive battery 16 to the auxiliary unit 11, and when the power consumption of the auxiliary load 12 is equal to or higher than a predetermined power, drives the engine 14 and the alternator 15 to supplement the power to the auxiliary unit 11.

According to the vehicle power supply system 10, as will be described in detail later, it is possible to avoid a situation in which the voltage of the auxiliary battery 13 significantly decreases and falls below the operation voltage of the auxiliary unit 11.

The auxiliary load 12 is a device that consumes electric power, such as an electrical component in the vehicle, a control device that controls the electrical component, a control device related to traveling, and a control device that controls automatic driving, and is, for example, a brake motor, a power steering motor, or the like.

The auxiliary battery 13 supplies electric power to the auxiliary load 12 and is a battery having a lower voltage and a smaller capacity than the driving battery 16 described later. As the auxiliary battery 13, a lead battery, a lithium ion battery may be used. The auxiliary battery 13 is provided with a battery sensor 18. The battery sensor 18 detects the voltage of the auxiliary battery 13, the current on the charging side, or the current on the discharging side.

The alternator 15 is a generator that generates electric power by the rotation of the engine 14, and supplies electric power to the auxiliary unit 11. The alternator 15 may be connected to the crankshaft of the engine 14 by a belt. The alternator 15 is connected to the auxiliary unit 11 in parallel with the DCDC converter 17.

The drive battery 16 supplies electric power to a motor that drives the vehicle. A lithium ion battery may be used as the driving battery 16.

The DCDC converter 17 steps down the voltage of the DC high-voltage power of the driving battery 16 to the voltage of the DC low-voltage power and supplies the voltage to the auxiliary unit 11. The DCDC converter 17 is connected to the auxiliary unit 11 in parallel with the alternator 15.

### [Power Supply ECU]

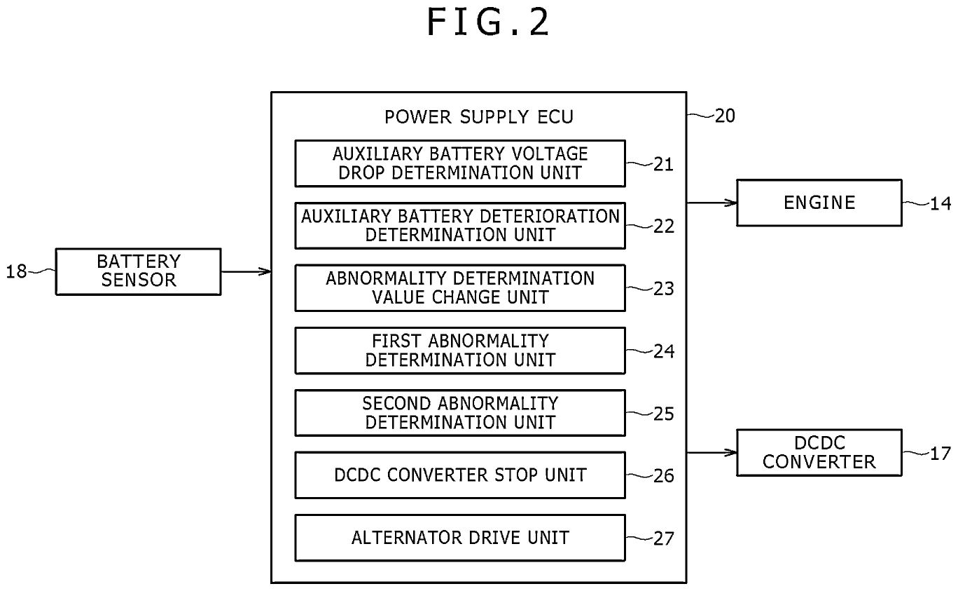

The power supply ECU 20 will be described with reference to FIG. 2.

The power supply ECU 20 normally drives the DCDC converter 17 to supply electric power of the drive battery 16 to the auxiliary unit 11. When the power consumption of the auxiliary load 12 is equal to or greater than the predetermined power, the power supply ECU 20 drives the engine 14 and the alternator 15 to supply power to the auxiliary unit 11. The power supply ECU 20 executes DCDC abnormality determination control for stopping the DCDC converter 17 and driving the alternator 15 when the DCDC converter 17 is abnormal, which will be described in detail later.

The power supply ECU 20 includes a CPU (Central Processing Unit) serving as an arithmetic processing unit, and a storage unit such as a RAM (Random Access Memory) and a ROM (Read Only Memory), and performs signal processing in accordance with a program stored in the ROM in advance while using a temporary storage function of the RAM.

The power supply ECU 20 is connected to the engine 14 and the DCDC converter 17. The power supply ECU 20 stops or drives the engine 14 or the DCDC converter 17. The battery sensor 18 is connected to the power supply ECU 20. The power supply ECU 20 acquires the voltage of the auxiliary battery 13 detected by the battery sensor 18, the current on the charging side, or the current on the discharging side.

The power supply ECU 20 includes an auxiliary battery voltage drop determination unit 21, an auxiliary battery deterioration determination unit 22, an abnormality determination value change unit 23, a first abnormality determination unit 24, a second abnormality determination unit 25, a DCDC converter stop unit 26, and an alternator drive unit 27, which will be described in detail later. The auxiliary battery voltage drop determination unit 21, the auxiliary battery deterioration determination unit 22, the abnormality determination value change unit 23, the first abnormality determination unit 24, the second abnormality determination unit 25, the DCDC converter stop unit 26, and the alternator drive unit 27 are realized by the CPU executing a program stored in the ROM or the RAM.

The auxiliary battery voltage decrease determination unit 21 determines whether the remaining capacity of the auxiliary battery 13 is small. More specifically, the auxiliary battery voltage decrease determination unit 21 determines whether the voltage of the auxiliary battery 13 detected by the battery sensor 18 is equal to or higher than a predetermined voltage. The predetermined voltage value is a voltage value at which it is determined that the remaining capacity of the auxiliary battery 13 is small, and is stored in the storage unit in advance.

The auxiliary battery deterioration determination unit 22 determines whether the auxiliary battery 13 is deteriorated. More specifically, the auxiliary battery deterioration determination unit 22 detects an internal resistance value of the auxiliary battery 13, and determines that the auxiliary battery 13 is deteriorated if the internal resistance value is equal to or less than a predetermined resistance value. The predetermined internal resistance value is a resistance value at which it is determined that the auxiliary battery 13 is degraded, and is stored in the storage unit in advance.

In some cases, the auxiliary battery voltage decrease determination unit 21 determines that the remaining capacity of the auxiliary battery 13 is small, or the auxiliary battery degradation determination unit 22 determines that the auxiliary battery 13 is degraded. At this time, the abnormality determination value changing unit 23 sets the determination voltage value to be low in a first abnormality determination unit 24 to be described later, and sets the determination current value to be low in a second abnormality determination unit 25 to be described later.

Here, the auxiliary battery 13 may be deteriorated or the remaining capacity of the auxiliary battery 13 may be small. At this time, when the DCDC converter 17 is abnormal, if the DCDC converter 17 is stopped and the alternator 15 is driven, a short-term large current is generated in the auxiliary load 12 having a large load such as a brake motor or a power steering motor. At this time, there is a possibility that the voltage of the auxiliary battery 13 significantly decreases and becomes lower than the operating voltage of the auxiliary unit 11, that is, a so-called battery rise may occur.

Therefore, when the remaining capacity of the auxiliary battery 13 is small or the auxiliary battery 13 is degraded, the abnormality determination value changing unit 23 strictly determines the abnormality of the DCDC converter 17 to be executed later, and stops the DCDC converter 17 early to drive the alternator 15. Thus, when a short-term large current is generated in the auxiliary load 12, the voltage of the auxiliary battery 13 is prevented from significantly decreasing.

The first abnormality determination unit 24 determines whether the DCDC converter 17 is abnormal when the auxiliary battery 13 is being charged. More specifically, when the auxiliary battery 13 is being charged and the difference between the voltage value of the auxiliary battery 13 and the target voltage value of the electric power supplied to the auxiliary unit 11 is equal to or greater than the determination voltage value, the first abnormality determination unit 24 determines that the DCDC converter 17 is abnormal. This is because the voltage value of the auxiliary battery 13 and the target voltage value of the electric power supplied to the auxiliary unit 11 are the same when the DCDC converter 17 is normal and the auxiliary battery 13 is being charged. Here, the target voltage value is a voltage value output by the DCDC converter 17 set based on a request of the auxiliary load 12.

The second abnormality determination unit 25 determines whether the DCDC converter 17 is abnormal when the auxiliary battery 13 is not being charged. More specifically, the second abnormality determination unit 25 determines that the DCDC converter 17 is abnormal when the auxiliary battery 13 is not being charged and the current value on the discharge side of the auxiliary battery 13 is equal to or greater than the determination current value. The reason is that when the DCDC converter 17 is normal and the auxiliary battery 13 is not being charged, the electric power of the driving battery 16 is converted by the DCDC converter 17 and supplied to the auxiliary unit 11, so that the electric power is not discharged from the auxiliary battery 13 to the auxiliary load 12.

In some cases, the first abnormality determination unit 24 or the second abnormality determination unit 25 determines that the DCDC converter 17 is abnormal. At this time, the DCDC converter stop unit 26 stops the DCDC converter 17.

When the DCDC converter 17 is stopped in the DCDC converter stop unit 26, the alternator drive unit 27 drives the engine 14 to drive the alternator 15.

According to the DCDC converter stopping unit 26 and the alternator driving unit 27, since traveling can be continued without depending on the remaining amount of electric power of the auxiliary battery 13, reliability during traveling can be improved. In addition, the greater the degree of power consumption of the auxiliary battery 13, the more the deterioration of the auxiliary battery 13 progresses. Therefore, the alternator 15 is used instead of the auxiliary battery 13. Accordingly, power consumption of the auxiliary battery 13 can be suppressed, and deterioration of the auxiliary battery 13 can be suppressed.

### [Abnormality Determination Control]

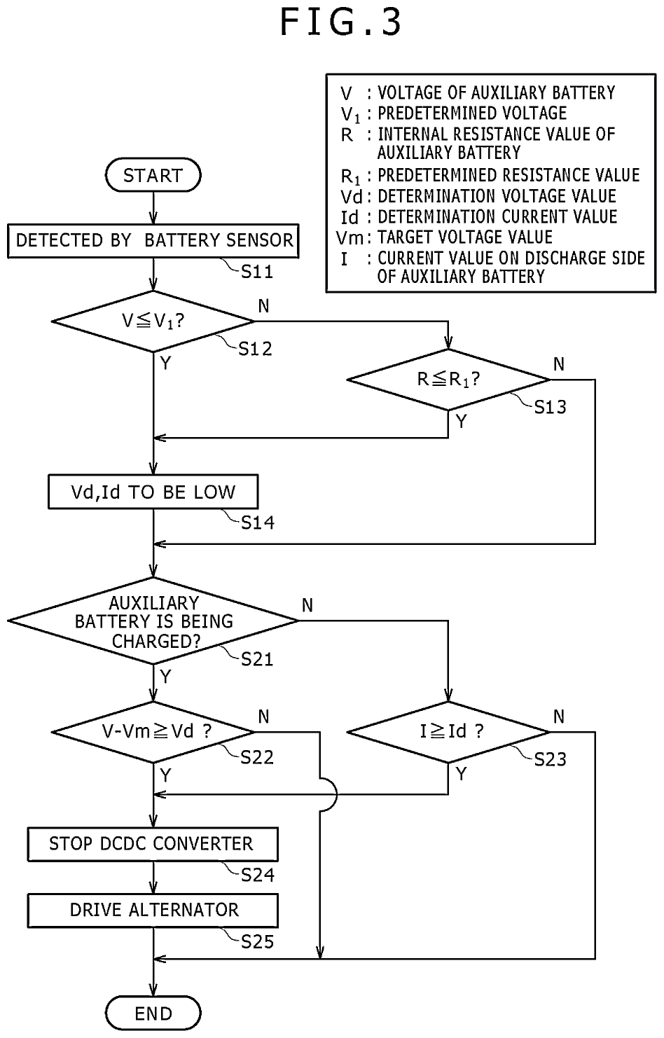

The flow of the DCDC abnormality determination control will be described with reference to FIG. 3.

In the DCDC abnormality determination control, an abnormality of the DCDC converter 17 is determined based on each function of the power supply ECU 20 described above in accordance with the following procedure. In step S11, the voltage value of the auxiliary battery 13 detected by the battery sensor 18, and the current value on the charging side or the current value on the discharging side are acquired.

In step S12, the auxiliary battery voltage drop determination unit 21 determines whether the voltage of the auxiliary battery 13 is equal to or lower than a predetermined voltage. When the voltage of the auxiliary battery 13 is equal to or lower than the predetermined voltage, the process proceeds to step S14. When the voltage of the auxiliary battery 13 is higher than the predetermined voltage, the process proceeds to step S13.

In step S13, when the internal resistance value of the auxiliary battery 13 is equal to or less than the predetermined resistance value by the auxiliary battery deterioration determination unit 22, the process proceeds to step S14. When the internal resistance value of the auxiliary battery 13 is larger than the predetermined resistance value, the process proceeds to step S21.

In step S14, the abnormality determination value changing unit 23 sets the determination voltage value of the first abnormality determination unit 24 in step S22 to be described later to be low, and sets the determination current value of the second abnormality determination unit 25 in step S23 to be described later to be low.

In step S21, it is determined whether the auxiliary battery 13 is being charged. When the auxiliary battery 13 is being charged, the process proceeds to step S22. When the auxiliary battery 13 is not being charged, the process proceeds to step S23.

In step S22, the first abnormality determination unit 24 determines whether the difference between the voltage value of the auxiliary battery 13 and the target voltage value of the DCDC converter 17 is equal to or greater than the determination voltage value. When the difference between the voltage value of the auxiliary battery 13 and the target voltage value of the DCDC converter 17 is equal to or greater than the determination voltage value, the process proceeds to step S24.

In step S23, the second abnormality determination unit 25 determines whether the current value on the discharge side of the auxiliary battery 13 is equal to or greater than the determination current value. When the current value on the discharge side of the auxiliary battery 13 is equal to or greater than the determination current value, the process proceeds to step S24.

In step S24, the DCDC converter stop unit 26 determines that the DCDC converter 17 is abnormal, and stops the DCDC converter 17. In step S25, the engine 14 is driven to drive the alternator 15.

Note that the present disclosure is not limited to the above-described embodiments and modifications thereof, and it is needless to say that various modifications and improvements can be made within the scope of the matters described in the claims of the present application.

1. A vehicle power supply system comprising:
an auxiliary unit;
an auxiliary battery that supplies electric power to the auxiliary unit;
an alternator that generates electric power by rotation of an engine and supplies electric power to the auxiliary unit and the auxiliary battery; and
a DCDC converter that is connected in parallel with the alternator and converts a voltage to supply electric power of a driving battery to the auxiliary unit and the auxiliary battery,
when the auxiliary battery is being charged and a difference between a voltage value of the auxiliary battery and a target voltage value of the DCDC converter is equal to or greater than a determination voltage difference, it is determined that the DCDC converter is abnormal, the DCDC converter is stopped, and the alternator is driven, and
wherein when the voltage value of the auxiliary battery is equal to or less than a predetermined voltage value or an internal resistance value of the auxiliary battery is equal to or less than a predetermined resistance value, the determination voltage difference is lowered.

2. The vehicle power supply system according to claim 1,
wherein when the auxiliary battery is not being charged and the current value of the auxiliary battery on a discharge side is equal to or greater than a determination current value, it is determined that the DCDC converter is abnormal, the DCDC converter is stopped, and the alternator is driven, and
when the voltage value of the auxiliary battery is equal to or less than the predetermined voltage value or the internal resistance value of the auxiliary battery is equal to or less than the predetermined resistance value, the determination current value is lowered.
